(19) United States
(12) Patent Application Publication
(10) Pub. No.: US 2011/0149826 A1
(43) Pub. Date: Jun. 23, 2011

(54) BROADCASTING MEDIA ACCESS CONTROL DEVICE FOR TRANSMITTING AND RECEIVING PACKETS IN MULTI-CHANNEL BROADCASTING NETWORK

(75) Inventor: Dong Joon CHOI, Daejeon (KR)

(73) Assignee: Electronics and Telecommunications Research Institute, Daejeon (KR)

(21) Appl. No.: 12/941,785

(22) Filed: Nov. 8, 2010

(30) Foreign Application Priority Data
Dec. 18, 2009 (KR) 10-2009-0127261

(51) Int. Cl. H04W 4/06

(52) U.S. Cl. 370/312

(57) ABSTRACT

Provided is a Broadcasting Media Access Control (BMAC) device for providing a high-speed and high-capacity broadcasting service via a multi-channel broadcasting network. The BMAC device includes: an input packet classifier for generating a BMAC packet by inserting a serial number according to an input order of a plurality of input packets constituting one of contents; a BMAC packet scheduler for distributing the BMAC packet into a plurality of channels; and a plurality of encapsulators for multiplexing the BMAC packet distributed into the plurality of channels into a transport stream.

### CROSS-REFERENCE TO RELATED APPLICATIONS

This U.S. non-provisional patent application claims priority under 35 U.S.C. §119 of Korean Patent Application No. 10-2009-0127261, filed on Dec. 18, 2009, the entire contents of which are hereby incorporated by reference.

### BACKGROUND OF THE INVENTION

The present invention disclosed herein relates to a multi-channel broadcasting network, and more particularly, to a Broadcasting Media Access Control (BMAC) device for providing a high-speed and high-capacity broadcasting service via a multi-channel broadcasting network.

Current broadcasting services are provided via broadcasting networks of various types such as satellites, cables, terrestrial waves, and Digital Multimedia Broadcastings (DMBs). Through these broadcasting networks, digital broadcasting services such as Standard Definition (SD) and High Definition (HD) broadcasting services in addition to an existing analog broadcasting service may be provided. A user data transmission rate available in one channel may vary according to channel attributes such as a bandwidth per channel and modulation and demodulation methods of each broadcasting network.

[Table 1] shows a transmission rate for each channel of a currently available domestic broadcasting network.

TABLE 1

| | | | Maximum |
|---|---|---|---|
| Broadcasting | Bandwidth per | Transmission | transmission rate |
| network | channel | method | per channel |
| Terrestrial wave | 6 MHz | 8 VSB | 19.392 Mbps |
| (ATSC) | | | |
| DMB | 1.536 MHz | COFDM, ½ | 1.15 Mbps |
| Satellite (DVB-S) | 27 MHz | QPSK, ⅞ | 37.275 Mbps |
| Cable | 6 MHz | 64QAM | 26.97035 Mbps |
| | | 256QAM | 38.8107 Mbps |

As shown in [Table 1], there is no limitation in providing SD or HD broadcasting services via most of broadcasting networks except for a current DMB network. However, the currently available broadcasting networks are not suitable for providing high-capacity and high-quality broadcasting services that will be launched in the future such as 3-Dimensional Televisions (3DTVs), Ultra High Definition Televisions (UHDTVs), or multi-view broadcastings. In most typical broadcasting channels, each channel has a bandwidth of about 6 MHz. In order to provide the next generation high-capacity and high-quality broadcasting services, each channel should expand by a bandwidth of more than about 6 MHz or new high-efficiency transmission methods should be developed. However, there are various kinds of limitations in realizing a high-speed processing system for processing a wideband of more than about 6 MHz and improving transmission efficiency in a unit band.

### SUMMARY OF THE INVENTION

The present invention provides a Broadcasting Media Access Control (BMAC) device for transmitting and receiving high-capacity and high-capacity contents (which cannot be transmitted through only one channel) through a plurality of channel bondings.

Embodiments of the present invention provide Broadcasting Media Access Control (BMAC) devices for transmission including: an input packet classifier for generating a BMAC packet by inserting a serial number according to an input order of a plurality of input packets constituting one of contents; a BMAC packet scheduler for distributing the BMAC packet into a plurality of channels; and a plurality of encapsulators for multiplexing the BMAC packet distributed into the plurality of channels into a transport stream.

In some embodiments, the input packet classifier may search an attribute of the input packet from an input packet information table and may add a BMAC packet header to the input packet.

In other embodiments, the attribute of the input packet may include a broadcasting channel to be used for transmission and priority.

In still other embodiments, the serial number may be inserted into the BMAC packet header.

In even other embodiments, the BMAC packet header may be defined using a Data Over Cable Service Interface (DOCSIS) Media Access Control (MAC) frame structure.

In yet other embodiments, the BMAC packet header may include an expansion header for channel bonding and a Payload Header Suppression (PHS) header information for removing overlapping packet headers.

In further embodiments, the BMAC packet distributed into the plurality of channels may be mapped into a payload of a continuous transport stream.

In still further embodiments, the packet scheduler may control each channel through which the BMAC packet is transmitted and a transmission rate of each transport channel.

In even further embodiments, a protocol stack including a BMAC layer for distributing one of contents into the plurality of channels and transmitting the distributed one of contents may be provided to the plurality of channels.

In yet further embodiments, the BMAC layer may be defined in an upper level of a transport stream layer of the protocol stack.

In yet further embodiments, the serial number may be inserted into the input packet through the BMAC layer.

In yet further embodiments, the multiplexed transport streams may be Internet Protocol (IP) encapsulated and transmitted through the plurality of channels.

In yet further embodiments, a PHS, through which identically repeating portions in a user data region are compressed and the compressed portion is indicated with an index, may be applied to the IP packet.

In yet further embodiments, the index may be set using a DOCSIS MAC expansion header or a BMAC packet header in the PHS.

In other embodiments of the present invention, BMAC devices for receiving include: a plurality of decapsulators for extracting a plurality of BMAC packets with reference to Packet Identifiers (PIDs) of a plurality of transport streams received through a plurality of channels; a packet reorder for obtaining currently-transmitting channel bonding transport information from the BMAC packet using a BMAC management message, and setting channel bonding IDs of a program to be received in a BMAC information table through the obtained channel bonding transport information; a packet header processor for extracting a packet with a channel bonding ID set in the BMAC information table from the plurality of BMAC packets, reordering the BMAC packet in an original order through a serial number in a header of the extracted packets, and restoring an index of a compressed header into an original packet; and an output packet scheduler for outputting the restored original packet into an application receiver.

In some embodiments, the BMAC information table may include channel bonding related information, PHS information, and an available transport channel attribute description message.

In other embodiments, the channel bonding related information may include a channel bonding Identification (ID), a channel list transmitted from a corresponding ID, and a waiting time until the next packet is received during reordering.

In still other embodiments, the PHS information may include a PHS region, a PHS size, and a PHS mask.

In even other embodiments, the channel bonding related information, the PHS information, and the available transport channel attribute description message may constitute one BMAC management message.

In yet other embodiments, the BMAC management message may have a form where the channel bonding related information and the PHS information are stored in a payload of a DOCSIS MAC management message.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a configuration of a broadcasting service transmitting and receiving system using a plurality of heterogeneous broadcasting networks according to an embodiment of the present invention;

FIG. 2 is a view illustrating a transmission packet distribution form when a plurality of heterogeneous broadcasting network channels are combined according to a broadcasting service transmitting and receiving method;

FIG. 3 is a view illustrating a structure of a protocol stack used for providing services in an existing broadcasting network;

FIG. 4 is a view illustrating a structure of a protocol stack with an applied BMAC layer according to an embodiment of the present invention;

FIG. 5 is a view illustrating a packet format of an MPEG-2 TS transmitted through the BMAC layer of FIG. 4;

FIG. 6 is a view illustrating a BMAC frame structure (for example, a BMAC frame header) defined using a DOCSIS MAC frame structure in an existing cable network according to an embodiment of the present invention;

FIG. 7 is a view illustrating PHS according to an embodiment of the present invention;

FIG. 8 is a view illustrating a detailed configuration of a BMAC transmission processor according to an embodiment of the present invention;

FIG. 9 is a view illustrating a detailed configuration of a BMAC receiving processor according to an embodiment of the present invention; and

FIG. 10 is a view illustrating a basic format of a DOCSIS MAC management message used in a cable network.

### DETAILED DESCRIPTION OF SOME EMBODIMENTS

Some embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout.

A Broadcasting Media Access Control (BMAC) device of the present invention transmits and receives high-capacity and high-quality contents services (which cannot be transmitted because of limitations of a typical transmission bandwidth) through a plurality of broadcasting channel bondings. A BMAC structure is configured to transmit and receive one broadcasting service through a plurality of physical channels. A multi-channel transmission for one program may be used to provide high-capacity and high-quality broadcasting services and its remaining bandwidth in each individual channel may be utilized. Accordingly, broadcasting resource utilization may be enhanced.

For example, a transmission rate of an about 25 Mbps is required to transmit 3-Dimensional High Definition Television (3D HDTV) broadcasting services through a currently and widely used MPEG-2 compression method without deterioration. Accordingly, it is actually impossible to transmit 3D HDTV broadcasting services as they are through a current terrestrial broadcasting network. However, when a plurality of channels (for example, two channels) are combined and used for transmission, the 3D HDTV services become possible. As another example, SD broadcasting services of about 3 to 5 Mbps are impossible with an MPEG-2 compression method in an DMB network, but if a plurality of DMB broadcasting channels (for example, 3 or 4 channels) are combined and used for transmission, the SD broadcasting services become possible.

Thus, a Media Access Control (MAC) device for supporting multi-channel bondings is required. According to the present invention, a BMAC device is provided as a MAC device of a new structure for supporting multi-channel bondings. Especially, the BMAC device may be directly applied to a broadcasting channel of one-way direction such as a broadcasting network. Accordingly, this may resolve the limitations that Data Over Cable Service Interface Specification (DOCSIS) 3.0 (i.e., data transmission standard of a cable network for supporting a bi-directional transmission structure) may not be directly applied to a one-way directional broadcasting channel.

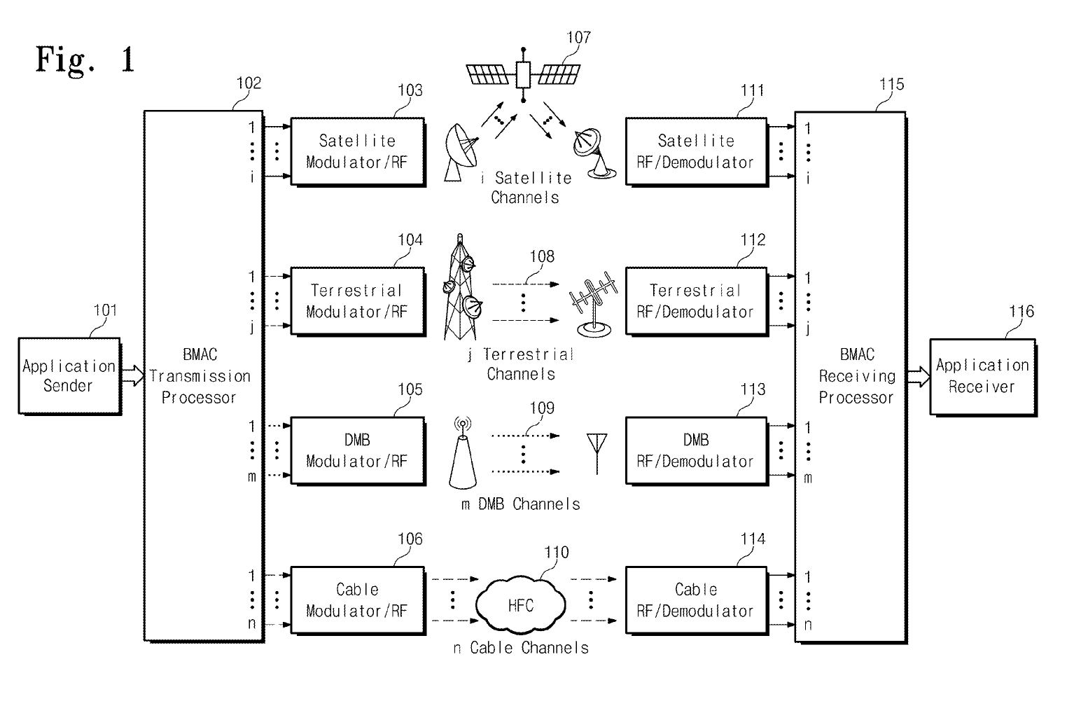

FIG. 1 is a view illustrating a configuration of a broadcasting service transmitting and receiving system using a plurality of heterogeneous broadcasting networks according to an embodiment of the present invention.

Referring to FIG. 1, i satellite channels 107, j terrestrial channels 108, m DMB channels 109, and n cable channels 110 may be used for transmitting and receiving broadcasting services (i, j, m, and n are natural numbers). A broadcasting service transmitting and receiving method that will be described below is not limited to bondings of broadcasting channels of specific forms and thus, may be applied to bondings of broadcasting channels of various forms.

In some embodiments, when an UHDTV broadcasting program with a transmission rate of about 120 Mbps is transmitted, 3 terrestrial channels (i.e., 3×19.392 Mbps=58.716 Mbps) 108, one satellite channel (37 Mbps) 107, and one cable channel (38.8107 Mbps) 110 may be used for transmission. That is, a high-capacity and high-quality broadcasting service that cannot be transmitted through a single channel may be transmitted through a plurality of bonding channels using a plurality of respectively heterogeneous broadcasting networks. At this point, contents outputted from an application sender 101 are transmitted using a plurality of transmitters 103, 104, 105, and 106 corresponding to a plurality of broadcasting networks selected by a broadcasting MAC transmission processor 102 (hereinafter, a BMAC transmission processor) that may be commonly applied to heterogeneous networks. The contents received through the plurality of receivers 111, 112, 113, and 114 corresponding to the respective broadcasting networks are restored using a BMAC receiving processor 115 (hereinafter, a BMAC receiving processor) and then restored contents are delivered to an application receiver 116.

In another embodiment, the present invention may transmit one SD program via three DMB networks 109 by using the BMAC transmission processor 102. Then, the SD program received via the three DMB networks 109 is restored to one SD program by using the BMAC receiving processor 115 and then the restored one SD program is delivered to the application receiver 116. According to the above-mentioned configuration of the present invention, services for contents, which may not be transmitted because of limitations of an existing transmission bandwidth, are possible through a plurality of broadcasting channel bondings.

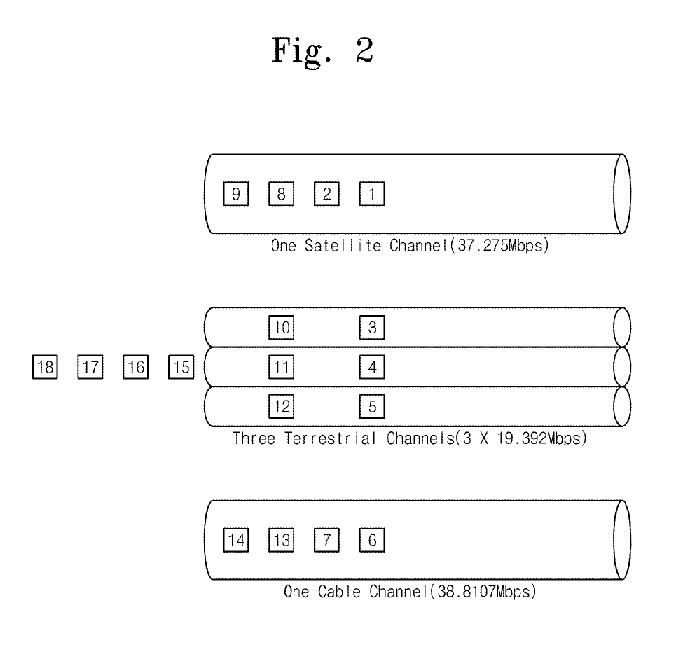

FIG. 2 is a view illustrating a transmission packet distribution form when a plurality of heterogeneous broadcasting network channels are combined according to a broadcasting service transmitting and receiving method. In FIG. 2, there are a configuration for assigning a serial number to a transmission packet of the BMAC transmission processor 102 and a configuration for restoring a packet order based on a serial number in the BMAC receiving processor 115 when a plurality of heterogeneous broadcasting network channels are combined.

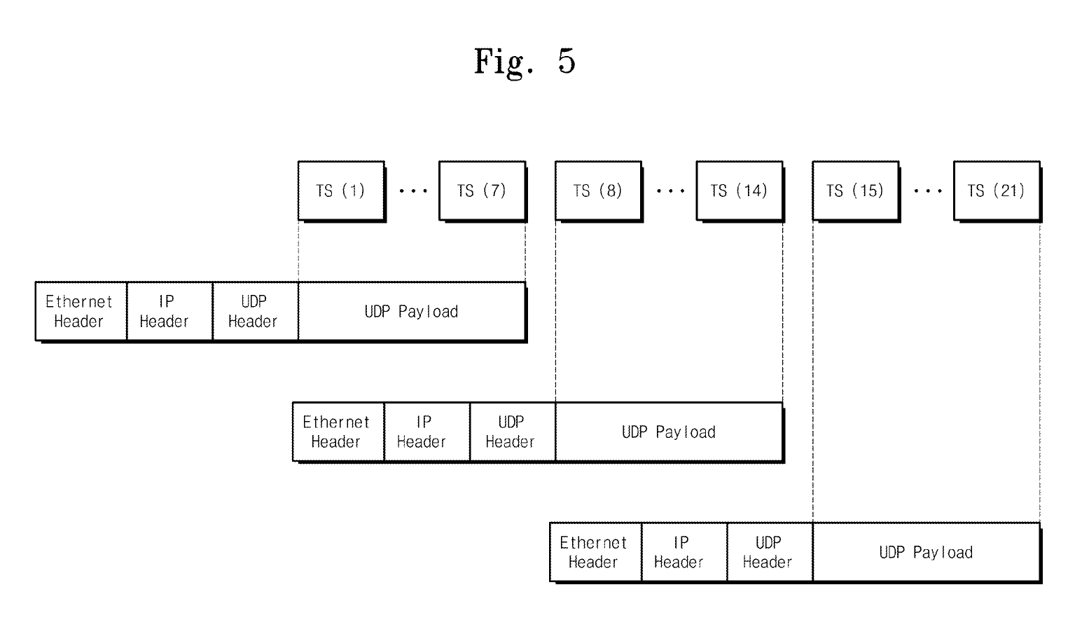

Referring to FIGS. 1 and 2, when channels are combined in the plurality of heterogeneous broadcasting networks, a packet inputted to each channel may be determined according to a scheduling policy of the BMAC transmission processor 102. For example, the BMAC transmission processor 102 assigns a serial number to a packet header for each packet, and then transmits each packet with the assigned serial number via one of the plurality of heterogeneous broadcasting network channels. The assigned serial number of each packet is inserted through a BMAC layer that is newly defined as an upper level of an MPEG-2 Transport Stream (TS) layer. Accordingly, channel bonding transmission becomes possible without modifying an existing MPEG-2 TS layer or an existing physical layer. A detailed configuration of the BMAC layer according to the present invention will be described below with reference to FIG. 4.

The BMAC receiving processor 115 reorders the received packets based on the serial numbers of the packets inputted into the receivers 111, 112, 113, and 114 of each network during packet reception. In this case, a packet with an earlier serial number may arrive at the receiving end after a packet with a later serial number, depending on the state of a transport channel. Accordingly, the BMAC receiving processor 115 has a configuration for storing packets for a predetermined time by considering transmission delay attribute of networks, in order to process a channel reorder.

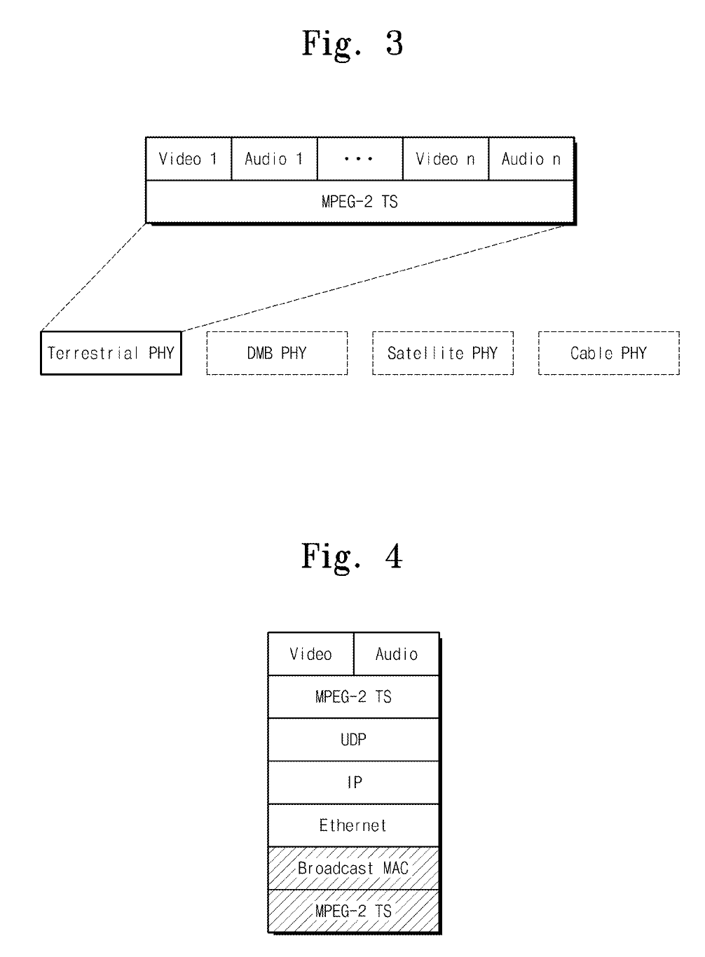

FIG. 3 is a view illustrating a structure of a protocol stack used for providing services in an existing broadcasting network.

Referring to FIG. 3, a plurality of video/audio programs (for example, the n number of video/audio programs) are multiplexed into one transport stream (i.e., one MPEG-2 TS) and transmitted through physical layers corresponding to each broadcasting network in an existing broadcasting network. In this case, the MPEG-2 TS is provided so as to partially serve as a MAC layer, but a function for channel bonding transmission is not provided at all. Accordingly, a BMAC layer for a broadcasting service of a new form that performs channel bonding transmission without modifying an existing physical layer will be defined as follows.

FIG. 4 is a view illustrating a structure of a protocol stack with an applied BMAC layer according to an embodiment of the present invention. FIG. 5 is a view illustrating a packet format of an MPEG-2 TS transmitted through the BMAC layer of FIG. 4.

Referring to FIG. 4, the protocol stack of the present invention includes a BMAC layer that allows contents, which cannot be transmitted through one channel, to be transmitted through a plurality of channel bondings. The MPEG-2 TS of a broadcasting program where video/audio are multiplexed may have a configuration that interfaces with the BMAC transmission processor 102 or the BMAC receiving processor 115 via an existing Internet Protocol (IP) transmission network. For this, after the MPEG-2 TS of the broadcasting program is IP encapsulated with the format of FIG. 5, the IP encapsulation is transmitted the BMAC layer of FIG. 4.

Referring to FIG. 5, at least two MPEG-2 TSs may be loaded in a user datagram protocol (UDP) payload in each IP packet. Each UDP payload corresponds to an Ethernet header, IP header, and UDP header. Here, values of the Ethernet header, IP header, and UDP header may be configured to have predetermined values for each individual program.

Although it will be described in detail below, the BMAC layer of the present invention sets a serial number of a BMAC packet header in order to transmit an inputted packet through a plurality of channels. Moreover, user priorities, header compressions, BMAC header error correction codes and so forth are defined in the BMAC header in order to schedule BMAC packets according to an application service. These configurations and functions of the BMAC layer of the present invention may use a format of a data over cable service interface specification (DOCSIS) MAC frame defined in an existing cable network and may define a BMAC frame of a new format.

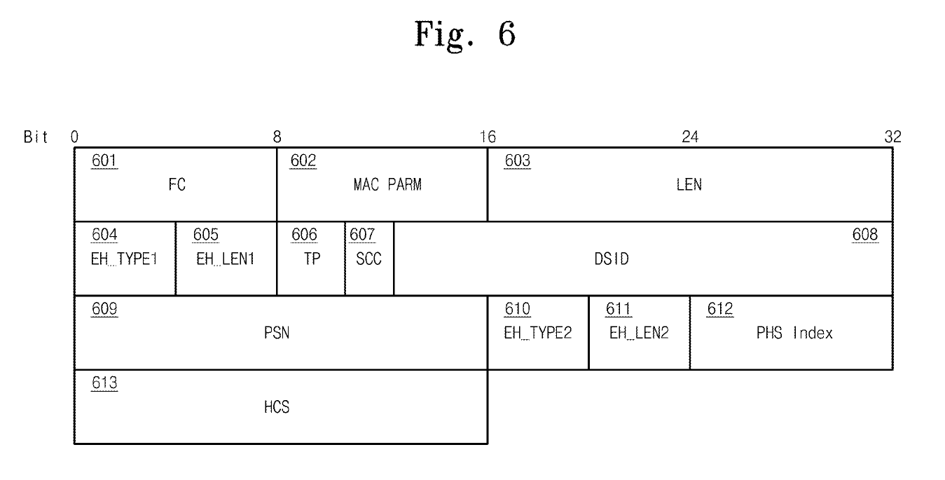

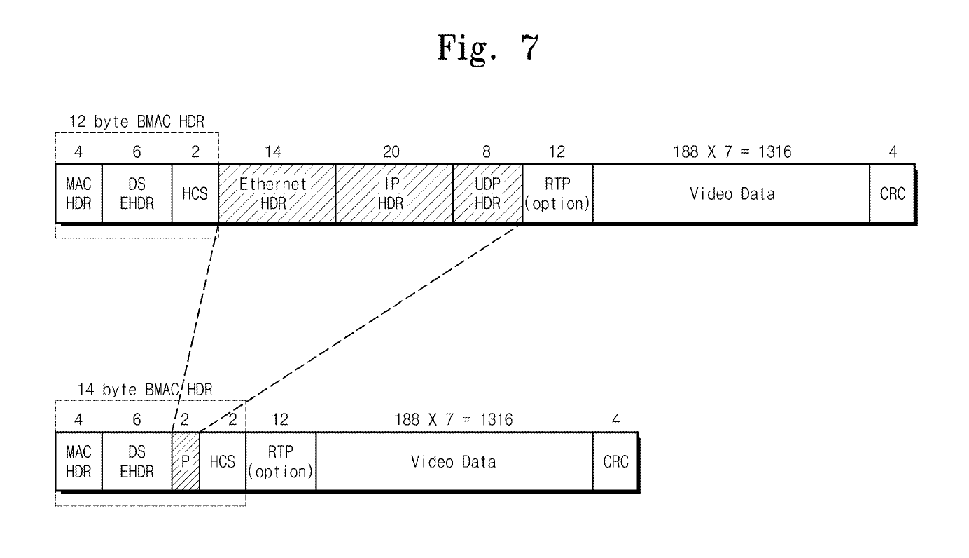

FIG. 6 is a view illustrating a BMAC frame structure (for example, a BMAC frame header) defined using a DOCSIS MAC frame structure in an existing cable network according to an embodiment of the present invention.

Referring to FIG. 6, the DOCSIS MAC header may include basic 6-byte MAC headers 601, 602, 603, and 823 and expansion headers 604, 605, 606, 607, 608, 609, 610, 611, and 612 may be further defined according to provided functions. According to the present invention, in order to provide a broadcasting service through a multi-channel, expansion headers for channel bonding 604, 605, 606, 607, 608, and 609 may be further added and in order to remove overlapping unnecessary packet headers among packets that a broadcasting service provides, payload header suppression (PHS) header information 610, 611, and 612 may be further added. The setting value of the BMAC frame header according to the present invention is shown in [Table 2].

TABLE 2

| Field | Bits | Value | |
|---|---|---|---|
| FC | 8 | 0x01 | EHDR_ON = 1 |
| MAC_PARAM | 8 | 0x08 | Expansion header |
| | | | length |
| LEN | 16 | | Packet PDU length + |
| | | | 6 (expansion |
| | | | header length) |
| EH_TYPE1 | 4 | 0x8 | |
| EH_LEN1 | 4 | 0x5 | |
| TP | 3 | | Packet processing |
| | | | priority |
| SCC | 1 | | Initializing flag bit |
| | | | of corresponding |
| | | | DSID |
| DSID | 20 | | Input program ID |
| PSN | 16 | | Packet serial |
| | | | number of |
| | | | corresponding |
| | | | program ID |
| EH_TYPE2 | 4 | 0x5 | |
| EH_LEN2 | 4 | 0x1 | |
| PHS Index | 8 | 0xFF | DSID-Indexed |
| | | | PHS |
| HCS | 16 | | Calculation from |
| | | | FC to PSN |

In the present invention, a packet configured with a BMAC frame is mapped into MPEG-2 TS like a DOCSIS structure and may use a physical layer of an existing broadcasting network without modifying it. The Packet Identifier (PID) of the MPEG-2 TS may be a newly scheduled value or 0x1FFE if it is DOCSIS MAC.

As shown in FIG. 5, when a video stream is IP encapsulated and transmitted, the Ethernet header, IP header, and UDP header have predetermined values for each individual program. Accordingly, the BMAC transmission processor 102 compresses portions that identically repeat in a user data region and indicates the compressed portions as an index for transmission. The BMAC receiving processor 115 restores an original value with respect to a corresponding index and transmits the restored original value, such that an amount of transmitted data can be reduced. This is called a payload header suppression (PHS).

FIG. 7 is a view illustrating PHS according to an embodiment of the present invention.

Referring to FIG. 7, if a DOCSIS MAC format is applied to the PHS, the present invention may set an index using a DOCSIS MAC expansion header or defines an additional BMAC header to set an index. If an index is set by defining an additional BMAC header, a PHS index may be defined as one field of the BMAC.

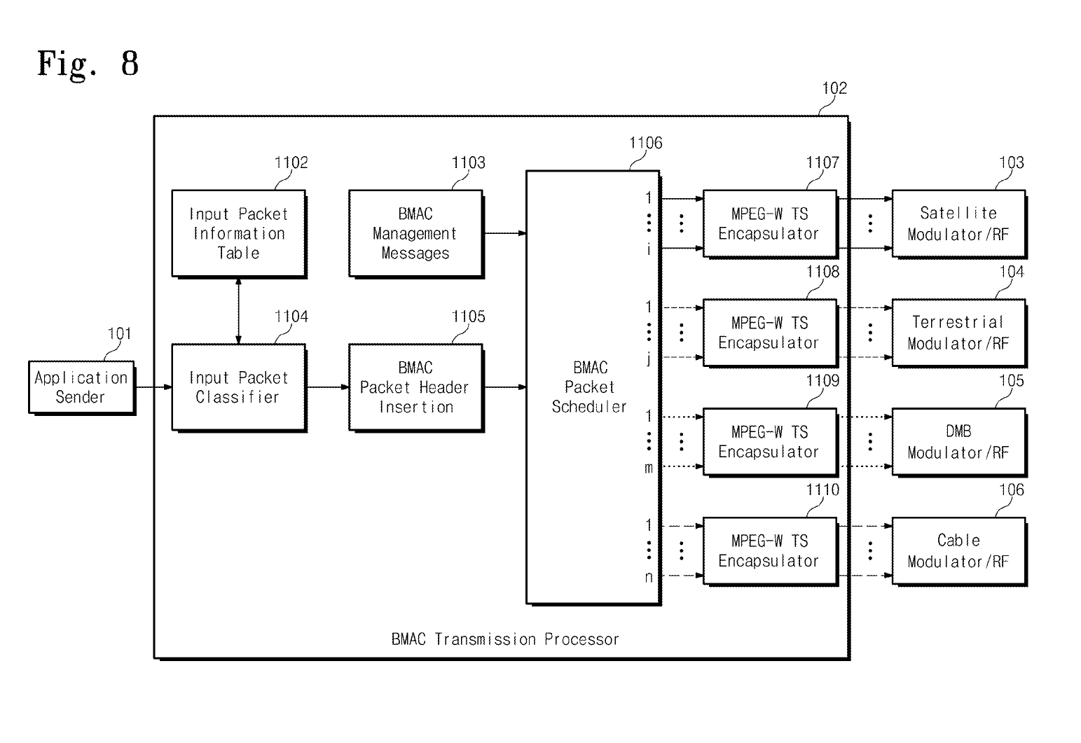

FIG. 8 is a view illustrating a detailed configuration of a BMAC transmission processor 102 according to an embodiment of the present invention.

Referring to FIG. 8, the BMAC transmission processor 102 includes an input packet information table 1102, an input packet classifier 1104, a BMAC packet scheduler 1106, and a plurality of MPEG-2 TS encapsulators 1107 to 1110.

A packet inputted into the BMAC transmission processor 102 may have a configuration that MPEG-2 TS packet is IP encapsulated as shown in FIG. 5. An input packet inputted from an application sender 101 is provided to the input packet classifier 1104. The input packet classifier 1104 searches attributes of the input packet (such as transmittable broadcasting channels and priorities) from the input packet information table 1102 where an attribute of a packet is stored. The input packet classifier 1104 generates a BMAC packet by adding the BMAC packet header (refer to BMAC HDR of FIG. 7) according to attributes that the input packet has. Here, the input packet classifier 1104 inserts a serial number into the BMAC packet according to an order of inputted packets (refer to 1105 of FIG. 8). The BMAC packet where the serial number is inserted is provided to the BMAC packet scheduler 1106.

The BMAC packet provided to the BMAC packet scheduler 1106 is transmitted through an arbitrary one channel selected from a plurality of channels according to a scheduling policy of the BMAC packet scheduler 1106. Here, the BMAC packet is mapped into payloads of continuous MPEG-2 TSs and then outputted. The MPEG-2 TS where the BMAC packet is mapped may determine its transmission rate according to an attribute of each broadcasting network connected to its backend. Accordingly, the BMAC packet scheduler 1106 of the present invention controls each channel through which an inputted packet is transmitted and a transmission rate of each channel. Moreover, when a packet is outputted via each network, the BMAC packet scheduler 1106 de-multiplexes the packet including MPEG-2 TS with only video/audio through a plurality of MPEG-2 TS encapsulators 1107 to 1110. In this case, the transmitting packet needs to be outputted with a remaining transmission rate after a transmission rate of the MPEG-2 TS with only video/audio is excluded from a transmission rate that is outputted through a channel of a broadcasting network.

Moreover, the BMAC transmission processor 102 transmits the BMAC management message (refer to 1103 of FIG. 8) in a predetermined period through all transport channels such that the BMAC receiving processor 115 may obtain information such as channel bonding IDs, transport channels, and header compressions of the transmitted BMAC packet.

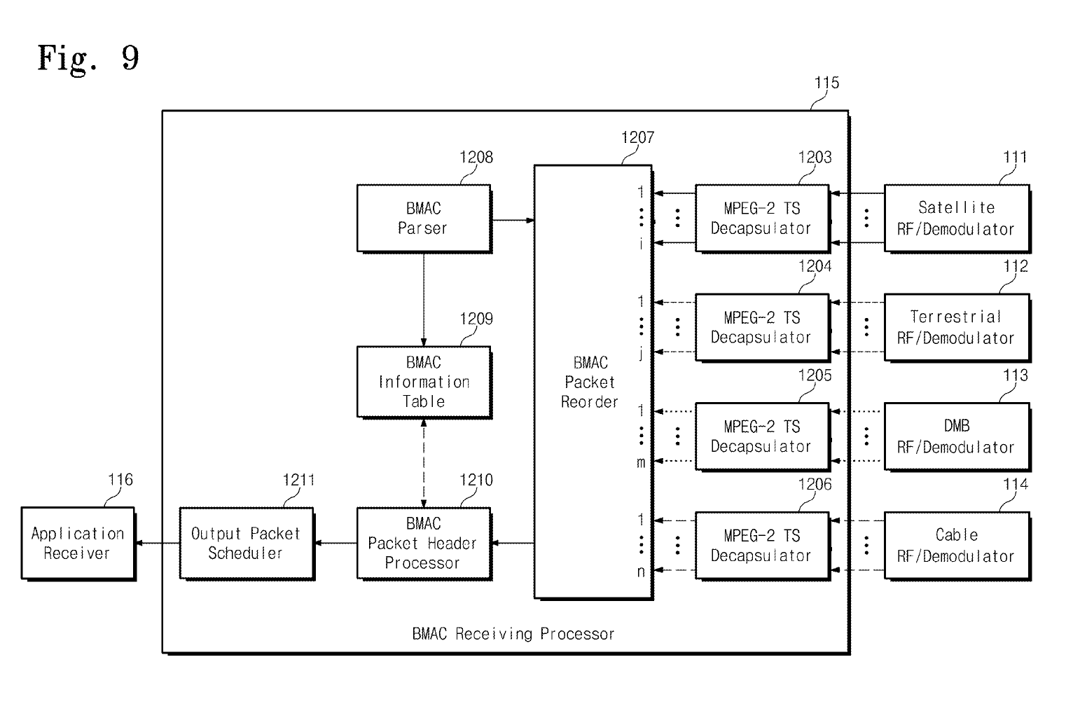

FIG. 9 is a view illustrating a detailed configuration of a BMAC receiving processor 115 according to an embodiment of the present invention.

Referring to FIG. 9, the BMAC receiving processor 115 includes a plurality of MPEG-2 TS decapsulators 1203 to 1206, a BMAC packet reorder 1207, a BMAC parser 1208, a BMAC information table 1209, a BMAC packet header processor 1210, and an output packet scheduler 1211.

The MPEG-2 TS streams received from receivers 111, 112, 113, and 114 of each transmission network 107, 108, 109, and 110 may have various PIDs. The MPEG-2 TS decapsulators 1203 to 1206 extract a BMAC packet from the MPEG-2 TS of which a PID is set for BMAC. Then, the MPEG-2 TS of which a PID is not set for BMAC is outputted to the video/audio decoding device without any processing.

Moreover, the BMAC packet reorder 1207 firstly extracts a BMAC management message from the BMAC packet and then, obtains currently-transmitting channel bonding transport information. The BMAC packet reorder 1207 sets channel bonding IDs of programs to be received in the BMAC information table 1209 by using the obtained channel bonding information. An operation for analyzing the channel bonding IDs may be performed by the BMAC parser 1208.

The BMAC packet header processor 1210 extracts only packets with channel bonding IDs set in the BMAC information table 1209 among a plurality of the received packets and uses serial numbers in headers of the extracted packets to perform a reorder operation for obtaining an original order. After the reorder operation of the BMAC packet header processor 1210, an index of a header of a BMAC packet where a payload header is compressed is restored such that an original packet is restored. The restored original packet is outputted to the application receiver 116 through the output packet scheduler 1211.

As mentioned above, the BMAC receiving processor 115 should obtain channel bonding related information shown in [Table 3] and store the information in the BMAC information table 1209 before channel combined programs are transmitted via multi-channel broadcasting networks.

TABLE 3

| | |
|---|---|
| Channel bonding related information | channel bonding ID |
| | channel list transmitted in |
| | corresponding ID |
| | waiting time until next packet is |
| | received during reorder |
| Payload header compression | payload header compression region |
| information | payload header compression size |
| | payload header compression mask |
| Available transport channel attribute | |
| description message | |

The channel bonding related information shown in [Table 3] may be configured as one management message and then transmitted. The BMAC management message for delivering program information may be delivered through service information (SI) and electronic program guide (EPG) information, which are used to deliver program information of each broadcasting network and are delivered with a MAC management message format.

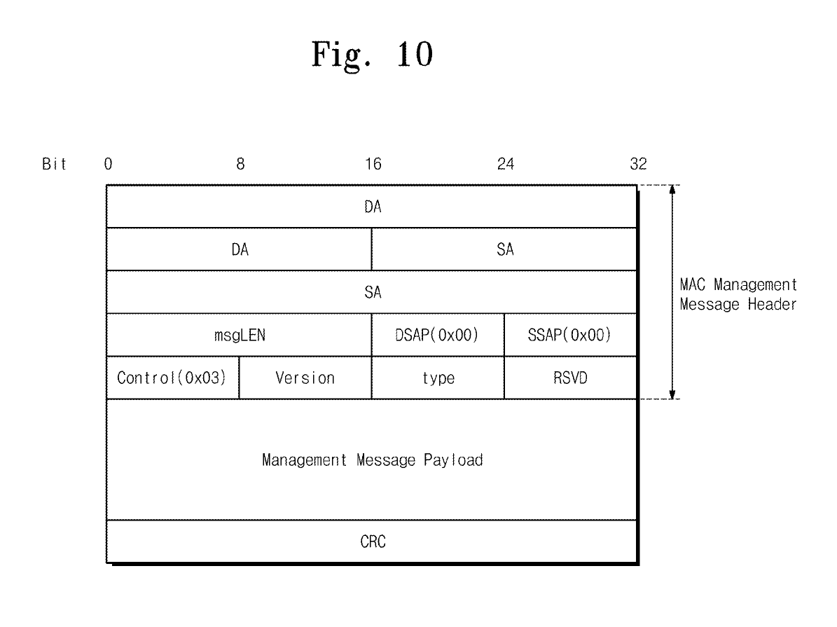

FIG. 10 is a view illustrating a basic format of a DOCSIS MAC management message used in a cable network.

Referring to FIG. 10, the DOCSIS MAC is MAC standards based on a bi-directional communication. Accordingly, form information related to channel bonding and header compression in the DOCSIS MAC may be set while a terminal is registered or a signaling process is performed later. However, in a case of a broadcasting network, since a bi-directional or a one-directional service is possible, the broadcasting network should support setting of form information related to a channel bonding and header compression regardless of its directivity. Accordingly, information set through registering and signaling in the DOCSIS MAC for supporting a bi-directional communication may be delivered to a terminal with a multicast form in a broadcasting network of a single direction according to the present invention.

In [Table 4], channel bonding related information and payload header compression message format are displayed in a type-length-value (TLV) format according to the present invention. In [Table 5], detailed information of an available transport channel attribute description message defined in the management message payload of FIG. 10 is shown with a TLV format.

TABLE 4

| Type | Length | Value |
|---|---|---|
| 50 | N | DSID Encodings |
| 50.1 | 3 | DSID (1-1048575) |
| 50.3 | N | Encoded resequencing attributes |
| 50.3.1 | 1 | 1 = DSID is a resequencing DSID |
| | | 0, 2-255: Reserved |
| 50.3.2 | n | DCID[1], DCID[2], . . . , DCID[n] |
| 50.3.3 | 1 | 1-180 (100 μ sec unit) |
| 26 | n | PHS Encodings |
| 26.7 | N | string of bytes compressed |
| 26.10 | 1 | Number of bytes in the |
| | | suppression string |

TABLE 5

| Length | Field |
|---|---|
| 1 | Count of changing channel |
| | transport channel attribute |
| | description message |
| 1 | Channel ID with message |

| Type | Length | Value |
|---|---|---|
| 1 | N | Currently available all transport |
| | | channel information |
| 1.1 | 1 | Transport channel ID |
| 1.2 | 1 | Transport channel network types |
| | | (satellite network, terrestrial |
| | | network, DMB network, cable |
| | | network, etc.) |
| 1.3 | 4 | Transport channel frequency |
| 1.4 | 1 | Modulation/demodulation and |
| | | channel encoding/decoding |
| | | method |

The channel bonding related information of the present invention may be defined in the management message payload of FIG. 10 according to the payload header compression message format shown in [Table 4]. The available transport channel attribute description messages may be defined in the management message payload of FIG. 10 according to a detailed field of [Table 5]. That is, by differently defining the degree of the management message payload of the DOCSIS MAC management message (refer to FIG. 10) used in an existing cable network, the BMAC management message defined according to the present invention may be configured. According to this configuration, the BMAC management message may be compatible with an existing DOCSIS MAC management message without conflicts.

As mentioned above, the BMAC device according to the present invention may transmit form information related to channel bonding and header compression to a device in a multicast form through a single directional transmission, regardless of whether a network provides a bi-directional transmission or not. Accordingly, service for contents that cannot be transmitted before because of limitations of a transmission bandwidth may be easily transmitted through a plurality of broadcasting channel bondings. Moreover, since an available BMAC structure in various broadcasting networks may be used, convergence services between respectively different broadcasting networks and communication networks may be provided without difficulties.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A Broadcasting Media Access Control (BMAC) device for transmission comprising:
an input packet classifier for generating a BMAC packet by inserting a serial number according to an input order of a plurality of input packets constituting one of contents;
a BMAC packet scheduler for distributing the BMAC packet into a plurality of channels; and
a plurality of encapsulators for multiplexing the BMAC packet distributed into the plurality of channels into a transport stream.

2. The BMAC device of claim 1, wherein the input packet classifier searches an attribute of the input packet from an input packet information table and adds a BMAC packet header to the input packet.

3. The BMAC device of claim 2, wherein the attribute of the input packet comprises a broadcasting channel to be used for transmission, and a priority.

4. The BMAC device of claim 2, wherein the serial number is inserted into the BMAC packet header.

5. The BMAC device of claim 2, wherein the BMAC packet header is defined using a Data Over Cable Service Interface (DOCSIS) Media Access Control (MAC) frame structure.

6. The BMAC device of claim 2, wherein the BMAC packet header comprises an expansion header for channel bonding and a Payload Header Suppression (PHS) header information for removing overlapping packet headers.

7. The BMAC device of claim 2, wherein the BMAC packet distributed into the plurality of channels is mapped into a payload of a continuous transport stream.

8. The BMAC device of claim 2, wherein the packet scheduler controls each channel through which the BMAC packet is transmitted and a transmission rate of each transport channel.

9. The BMAC device of claim 1, wherein a protocol stack including a BMAC layer for distributing one of contents into the plurality of channels and transmitting the distributed one of contents is provided to the plurality of channels.

10. The BMAC device of claim 9, wherein the BMAC layer is defined in an upper level of a transport stream layer of the protocol stack.

11. The BMAC device of claim 9, wherein the serial number is inserted into the input packet through the BMAC layer.

12. The BMAC device of claim 1, wherein the multiplexed transport streams are Internet Protocol (IP) encapsulated and transmitted through the plurality of channels.

13. The BMAC device of claim 12, wherein a PHS, through which identically repeating portions in a user data region are compressed and the compressed portion is indicated with an index, is applied to the IP packet.

14. The BMAC device of claim 13, wherein the index is set using a DOCSIS MAC expansion header or a BMAC packet header in the PHS.

15. A BMAC device for receiving comprising:
a plurality of decapsulators for extracting a plurality of BMAC packets with reference to Packet Identifiers (PIDs) of a plurality of transport streams received through a plurality of channels;
a packet reorder for obtaining currently-transmitting channel bonding transport information from the BMAC packet using a BMAC management message, and setting channel bonding IDs of a program to be received in a BMAC information table through the obtained channel bonding transport information;
a packet header processor for extracting a packet with a channel bonding ID set in the BMAC information table from the plurality of BMAC packets, reordering the BMAC packet in an original order through a serial number in a header of the extracted packets, and restoring an index of a compressed header into an original packet; and
an output packet scheduler for outputting the restored original packet into an application receiver.

16. The BMAC device of claim 15, wherein the BMAC information table comprises channel bonding related information, PHS information, and an available transport channel attribute description message.

17. The BMAC device of claim 16, wherein the channel bonding related information comprises a channel bonding Identification (ID), a channel list transmitted from a corresponding ID, and a waiting time until the next packet is received during reordering.

18. The BMAC device of claim 16, wherein the PHS information comprises a PHS region, a PHS size, and a PHS mask.

19. The BMAC device of claim 16, wherein the channel bonding related information, the PHS information, and the available transport channel attribute description message constitute one BMAC management message.

20. The BMAC device of claim 16, wherein the BMAC management message has a form where the channel bonding related information and the PHS information are stored in a payload of a DOCSIS MAC management message.
